(19) United States
(12) Patent Application Publication
(10) Pub. No.: US 2010/0224788 A1
(43) Pub. Date: Sep. 9, 2010

(54) VARIOUS ARRANGEMENTS OF RADIATION AND FISSILE MATERIALS DETECTION SYSTEMS USING SENSOR ARRAYS IN SPREADER BARS, GANTRY CRANES, SELF-PROPELLED FRAME STRUCTURES, AND TRANSPORT VEHICLES

(75) Inventor: DAVID L. FRANK, Highland Beach, FL (US)

Correspondence Address: FLEIT GIBBONS GUTMAN BONGINI & BIANCO P.L., ONE BOCA COMMERCE CENTER, 551 NORTHWEST 77TH STREET, SUITE 111, BOCA RATON, FL, 33487, US

(73) Assignee: Innovative American Technology, Inc., Coconut Creek, FL (US)

(21) Appl. No.: 12/698,598

(22) Filed: Feb. 2, 2010

Related U.S. Application Data
(63) Continuation-in-part of application No. 11/564,193, filed on Nov. 28, 2006.
Application No. 11/564,193 is a continuation-in-part of application No. 10/280,255, filed on Oct. 25, 2002, now Pat. No. 7,005,982.
Application No. 10/280,255 is a continuation-in-part of application No. 11/291,574, filed on Dec. 1, 2005, now Pat. No. 7,592,601.
Application No. 11/291,574 is a continuation-in-part of application No. 11/363,594, filed on Feb. 27, 2006, now Pat. No. 7,142,109.
(60) Provisional application No. 61/206,778, filed on Feb. 4, 2009.
(60) Provisional application No. 61/206,668, filed on Feb. 2, 2009.
(60) Provisional application No. 61/206,664, filed on Feb. 3, 2009.
(60) Provisional application No. 61/206,665, filed on Feb. 3, 2009.
(60) Provisional application No. 60/347,997, filed on Oct. 26, 2001.
(60) Provisional application No. 60/631,865, filed on Dec. 1, 2004.
(60) Provisional application No. 60/655,245, filed on Feb. 23, 2005.
(60) Provisional application No. 60/759,331, filed on Jan. 17, 2006.
(60) Provisional application No. 60/759,332, filed on Jan. 17, 2006.
(60) Provisional application No. 60/759,373, filed on Jan. 17, 2006.
(60) Provisional application No. 60/759,375, filed on Jan. 17, 2006.

(51) Int. Cl. G01T 1/36

(52) U.S. Cl. 250/390.04; 378/57

(57) ABSTRACT

Sensor arrays arranged in a detection system provide high performance detection of the presence of fissile material and radioactive material in cargo containers and at moderate cost. One or more sensor arrays operate to detect gamma and/or neutron radiation from one or more sides of a container that can be in transport relative to at least one of a spreader bar, a gantry crane, a self-propelled frame structure, and a transport vehicle. A combined use of any two or more of the following: a spreader bar radiation detector array, radiation detectors deployed on the frame of a gantry crane, extended radiation detectors, and a detector array deployed on a BOM cart, truck bed, or bottom area of the container, as the container is moved at a port enables comprehensive coverage of the container under inspection.

### CROSS-REFERENCE TO RELATED APPLICATIONS

This application is based upon and claims priority from co-pending provisional U.S. patent application No. 61/206,778, filed on Feb. 4, 2009, and co-pending provisional U.S. patent application No. 61/206,668, filed on Feb. 2, 2009, and co-pending provisional U.S. patent application No. 61/206,664, filed on Feb. 3, 2009, and co-pending provisional U.S. patent application No. 61/206,665, filed on Feb. 3, 2009, the collective entire disclosure of which being herein incorporated by reference.

This application is further a continuation in part of co-pending U.S. patent application Ser. No. 11/564,193, filed on Nov. 28, 2006, which was based on and claimed priority from prior co-pending U.S. Provisional Patent Application No. 60/759,332, filed on Jan. 17, 2006; and prior co-pending U.S. Provisional Patent Application No. 60/759,331, filed on Jan. 17, 2006; and prior co-pending U.S. Provisional Patent Application No. 60/759,373, filed on Jan. 17, 2006; and prior co-pending U.S. Provisional Patent Application No. 60/759,375, filed on Jan. 17, 2006; and furthermore was a continuation-in-part of prior co-pending U.S. patent application Ser. No. 11/291,574, filed on Dec. 1, 2005, which was a continuation-in-part of prior co-pending U.S. patent application Ser. No. 10/280,255, filed on Oct. 25, 2002, that was based on and claimed priority to prior co-pending U.S. Provisional Patent Application No. 60/347,997, filed on Oct. 26, 2001; and which further was based on, and claimed priority from, prior co-pending U.S. Provisional Patent Application No. 60/631,865, filed on Dec. 1, 2004, and prior co-pending U.S. Provisional Patent Application No. 60/655,245, filed on Feb. 23, 2005, and prior co-pending U.S. Provisional Patent Application No. 60/849,350, filed on Oct. 4, 2006, and which furthermore was a continuation-in-part of prior co-pending U.S. patent application Ser. No. 11/363,594 filed on Feb. 27, 2006; the collective entire disclosure of which being herein incorporated by reference.

### FIELD OF THE INVENTION

The present invention generally relates to the field of gamma and neutron detection systems associated with ports and cargo transport systems, and more particularly relates to high efficiency detection of gamma and neutron radiation from cargo containers in transport systems and ports.

### BACKGROUND OF THE INVENTION

Current designs for gantry crane mounted radiation detection systems utilize detectors mounted on a spreader bar that connects to a container at the top of the container. This provides a one sided sensor array that can fail to meet homeland security requirements for detection and identification of radiological and fissile materials that are shielded and placed at a remote location inside a container, such as at the bottom portion of the container. Recent concerns over the possibility of smuggling radiological or fissile materials to enable a dirty bomb or even an atomic bomb for use by terrorists creates a strong need for a more effective solution for radiation detection systems deployed on the equipment that facilitates transport of containers at a port. Due to the high volume of containers being transported at most major ports, the commercial viability of a radiation detection system is directly proportional to its impact on the flow of containers at a port and the overall cost of implementing such a detection system.

### SUMMARY OF THE INVENTION

According to one embodiment of the invention, a high performance design for a gantry crane radiation and fissile materials detection and identification system enables an efficient sensor configuration for a high performance capability with moderate costs. The gantry crane is typically a rail mounted gantry crane (RMG) or configured as a rubber tire gantry crane (RTG). The gantry crane radiation verification system (GCRVS) provides highly accurate and sensitive scanning of containers that are placed into or removed from the stack. The GCRVS deploys radiation sensors on the legs or sides of the gantry crane to form a target zone. Detector mounting panels are installed to form an array of gamma and or neutron detectors. The panels are designed to be one container high. Currently shipping containers are approximately nine feet high.

Sodium Iodide (NaI), Xenon, Plastic Scintillators or similar gamma detectors are deployed for scanning the container. The sensors are placed in close proximity to the container as it is loaded or offloaded from the truck.

Plastic scintillation detectors are used for neutron detection. The neutron detectors are deployed on the back side of each panel. The neutron detectors utilize collimators to assist in the directional indication of the fissile source material(s). The neutron detector data is provided to the spectral analysis software system to detect the presence of fissile materials and to determine the container that holds such materials.

The spreader bar radiation detector array and the deployment of radiation detectors on a frame structure in close proximity to a container to be inspected are both described in U.S. Pat. No. 7,142,109 “Container Verification System for Non-Invasive Detection of Contents”, the teachings of which being incorporated herein.

The detector array mounted on the gantry crane can be designed as a scanning array, a horizontal array across the container, or a combination scanning and horizontal array.

The horizontal array and/or the scanning array can be designed to cover the full height of the container. If the spreader bar detector array is used in combination with the side mounted array, the side mounted array may only need to be configured to cover the bottom half of the container.

A combined use of any two or more of the following: a spreader bar radiation detector array, radiation detectors deployed on the frame of a gantry crane, extended radiation detectors, and a detector array deployed on a BOM cart, truck bed, or bottom area of the container, as the container is moved at a port enables comprehensive coverage of the container under inspection.

Various sensor mounting arrangements and modular design are described to provide efficient and cost effective means to overcome difficulties of deploying arrays of gamma and neutron detectors on a spreader bar system, or other container movement equipment, for the collection of radiation spectral data, the digitization and processing of the detector data, the management of the detectors within the array, and the communications used to deliver the detector data to the processor for spectral analysis and isotope identification.

Specialized housings enable the integration of gamma and neutron detector arrays on a gantry crane spreader bar or on other container movement equipment. Sensor modules are designed to withstand harsh environmental conditions including: rain, heat, cold, vibration, shock, electromagnetic interference, radio frequency interference, and seaport environments. The sensor housings are designed to enable multiple detectors in a variety of types and sizes for optimum radiation detection and minimal space requirements. The sensor housings can be designed to be integrated into the push pull bar or the actual spreader bar of a spreader bar system to expand and contract the sensor positions for a variety of container sizes. The sensor housings are also designed for integration within the main body of the spreader bar system.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is a block diagram and associated picture illustrating an example of a spreader bar and gantry crane system with an integrated radiation detector array, according to one embodiment of the present invention.

FIG. 2 is a picture depicting an example gantry crane with both spreader bar and side mounted detector array, according to one embodiment of the present invention.

FIG. 3 is a picture depicting a spreader bar detection system for scanning a container under inspection and analysis of radiation and nuclear materials present in the container.

FIG. 4 is a block diagram showing a detection system with horizontal sensor arrays, according to one embodiment of the present invention.

FIG. 5 is a block diagram illustrating an Rubber Tired Gantry/Spreader Bar Sensor Array system, according to one embodiment of the present invention.

FIG. 6 is a block diagram illustrating container coverage by sensor arrays, according to one embodiment of the present invention.

FIG. 7 is a block diagram showing container scanning by Rubber Tired Gantry Scanning/Horizontal sensor arrays—Gamma, according to one embodiment of the present invention.

FIG. 8 is a block diagram showing container scanning by Rubber Tired Gantry Scanning/Horizontal sensor arrays—Neutron, according to one embodiment of the present invention.

FIG. 9 is a block diagram illustrating a spreader bar radiation verification system with flexible sensor extensions, according to one embodiment of the present invention.

FIG. 10 is a diagram illustrating a flexible sensor coil for use with a spreader bar radiation verification system with flexible sensor extensions, according to one embodiment of the present invention.

FIG. 11 is a diagram illustrating a spreader bar radiation verification system with folding sensors, according to one embodiment of the present invention.

FIG. 12 is a diagram illustrating a spreader bar radiation verification system—with Truck/BOM Cart bed detectors, according to one embodiment of the present invention.

FIG. 13 is a diagram illustrating a spreader bar radiation verification system—with detectors deployed on the lower portion of the container, according to one embodiment of the present invention.

FIGS. 14 to 19 illustrate various examples of placements and arrangements of sensor modules in association with a spreader bar radiation verification system.

FIGS. 20 and 21 show an example of a Sensor Integration Module and a High Voltage Power Supply, and supporting circuit components.

FIG. 22 is a circuit block diagram illustrating a voltage lock-in circuit.

FIG. 23 is a diagram illustrating an example of an arrangement of shock absorbers and sensor housings.

FIG. 24 is a block diagram illustrating an example of a control box used in a spreader bar radiation verification system.

FIG. 25 is a block diagram illustrating examples of a neutron pulse signal and a gamma pulse signal.

FIG. 26 is a block diagram illustrating a software control of calibration and synchronization for a radiation verification system, according to one embodiment of the present invention.

### DETAILED DESCRIPTION

As required, detailed embodiments of the present invention are disclosed herein; however, it is to be understood that the disclosed embodiments are merely examples of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure and function. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, software application, and other similar terms as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system. A data storage means, as defined herein, includes many different types of computer readable media that allow a computer to read data therefrom and that maintain the data stored for the computer to be able to read the data again. Such data storage means can include, for example, non-volatile memory, such as ROM, Flash memory, battery backed-up RAM, Disk drive memory, CD-ROM, DVD, and other permanent storage media. However, even volatile storage such as RAM, buffers, cache memory, and network circuits are contemplated to serve as such data storage means according to different embodiments of the present invention. A computer program product is a data storage means that is readable by a computer and that can provide information to the computer for use with a program, computer program, or software application.

The present invention, according to one embodiment, overcomes problems with the prior art by creating a distributed array of sensors in a multi-sided array, where one array is deployed on a spreader bar on top of the container and an additional detector array is mounted on one or more locations of the crane frame structure.

One embodiment of the invention includes gamma and neutron sensors that can be deployed in a distributed sensor network around a target area and configured as an array for vehicle/container analysis. The gamma and neutron sensors can be deployed on multiple sides of the detection area to provide adequate coverage of the container. The sensors can be configured as a one or more arrays positioned along the centerline of the container to minimize the number of sensors required and to optimize the data acquisition times.

The sensors are connected to at least one Sensor Integration Unit (SIU) that provides the calibration, automated gain control, calibration verification, remote diagnostics and connectivity to the processor for spectral analysis of the sensor data. An example of the SIU is described in U.S. Pat. No. 7,269,527 entitled “System integration module for CBRNE sensors”, which is herein incorporated by reference. The sensors may also be shielded from electromagnetic interference (EMI). A data collection system, electrically coupled with each sensor device, collects signals from the sensor devices. The collected signals represent whether, each sensor device has detected gamma or neutron radiation. Optionally, a remote monitoring system is communicatively coupled with the data collection system to remotely monitor the collected signals from the sensor devices and thereby remotely determine whether one or more gamma neutron sensor devices from the array have provided gamma data or neutron radiation data, and a spectral analysis system identifies the specific isotopes detected by the sensors, as will be more fully discussed below. A user interface provides sensor related data, such as a graphic presentation of the data from each sensor and group of sensors, the detection of radiation, and the identification of the one or more isotopes detected by the sensors.

Described now is an example of a Gantry Crane Radiation Verification System for radiation detection and isotope identification and the operation of the same, according to various embodiments of the present invention.

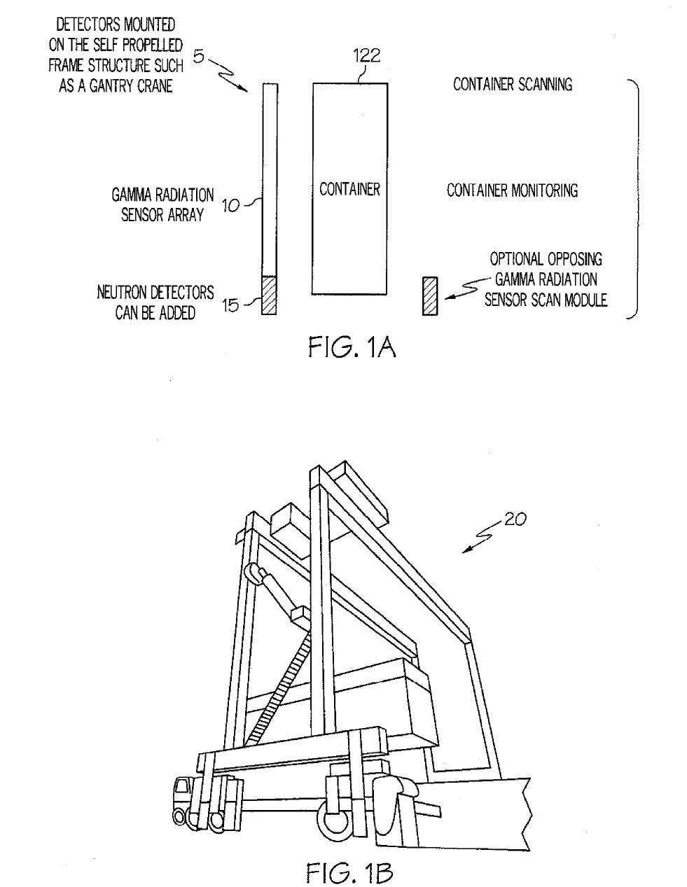

An example of sensor deployments for analysis of vehicles and cargo containers is illustrated in FIG. 1, and provides significantly improved efficiency and deployment capabilities over conventional detector systems. Here a truck is deployed under the far side of a rubber tired gantry crane (also referred to as RTG). The truck and container are scanned for radiological materials by the gamma detectors mounted on the side of the RTG frame. The truck and/or container can be further monitored for gamma radiation while standing and waiting for the RTG spreader bar to connect to the container and lift the container away from the truck and side detector array. The side detector array may also include neutron detectors.

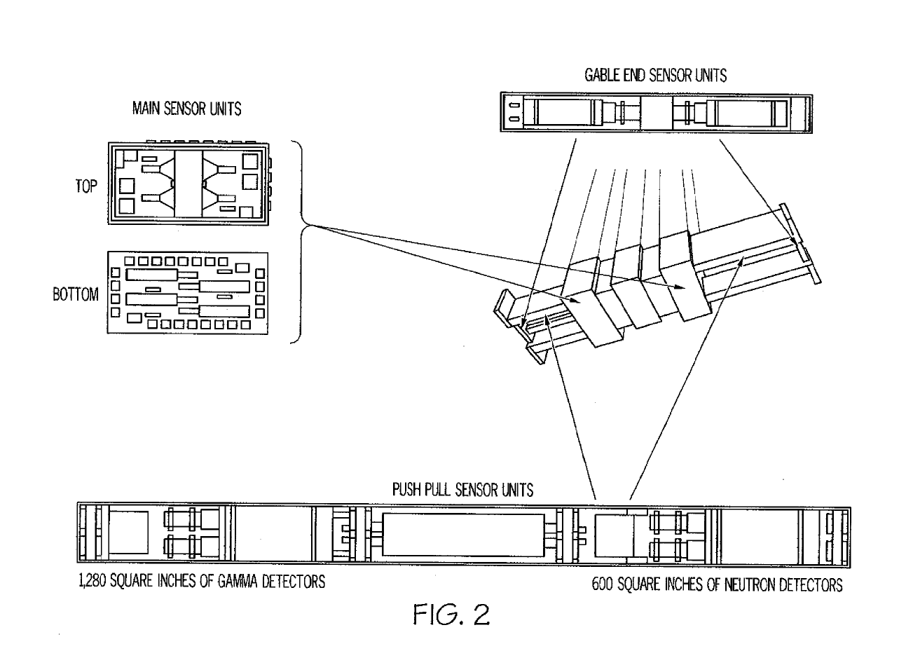

The spreader bar of the gantry crane, in this example, has gamma and/or neutron detector arrays deployed for non-invasive inspection of the container contents. With reference to FIG. 2, the container is inspected from the top by the spreader bar array of sensors and the bottom portion of the container is inspected by the gantry crane side mounted array of sensors.

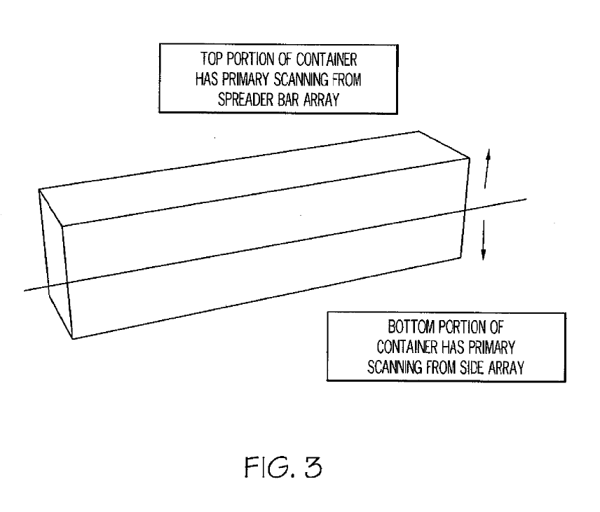

With reference to FIG. 3, the spreader bar provides top down coverage of the container while the side mounted sensors/detectors provide coverage for the bottom portion of the container.

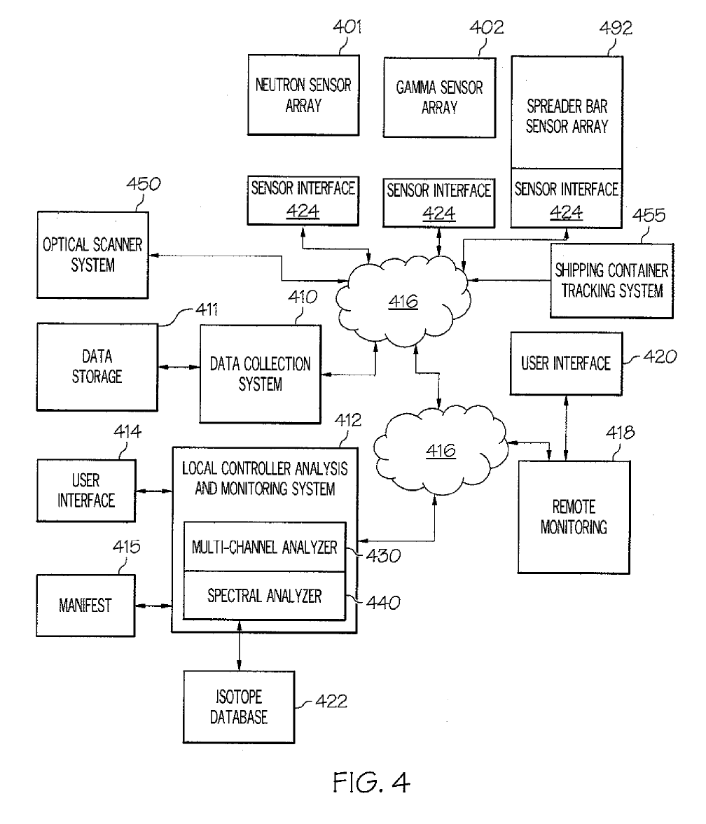

With reference to FIG. 4, a data collection system 410, in this example, is communicatively coupled via cabling, wireless communication link, and/or other communication link 405 with each of the gamma radiation sensor devices on the side mounted array 401, and the spreader bar mounted array 492 and neutron sensor devices 402 in each sensor unit. The data collection system 410 includes an information processing system with data communication interfaces 424 that collect signals from the radiation sensor units 401, 402, 492. The collected signals, in this example, represent detailed spectral data from each sensor device that has detected radiation. The data collection system 410 is modular in design and can be used specifically for radiation detection and identification, or for data collection for explosives and special materials detection and identification.

The data collection system 410 is communicatively coupled with a local controller and monitor system 412. The local system 412 comprises an information processing system that includes a computer, memory, storage, and a user interface 414 such a display on a monitor and a keyboard, or other user input/output device. In this example, the local system 412 also includes a multi-channel analyzer 430 and a spectral analyzer 440.

The multi-channel analyzer (MCA) 430 comprises a device composed of many single channel analyzers (SCA). The single channel analyzer interrogates analog signals received from the individual radiation detectors 401, 402, and determines whether the specific energy range of the received signal is equal to the range identified by the single channel. If the energy received is within the SCA the SCA counter is updated. Over time, the SCA counts are accumulated.

At a specific time interval, a multi-channel analyzer 430 includes a number of SCA counts, which results in the creation of a histogram. The histogram represents the spectral image of the radiation that is present. The MCA 430, according to one example, uses analog to digital converters combined with computer memory that is equivalent to thousands of SCAs and counters and is dramatically more powerful and cheaper.

The spectral analysis system 440 analyzes the collected detector radiation data and the histograms to detect radiation and to identify one or more isotopes associated with the detected radiation by using software on a computer program product. The histogram is used by the spectral analysis system 440 to identify isotopes that are present in materials contained in the container under examination. One of the functions performed by the information processing system 412 is spectral analysis, performed by the spectral analyzer 440, to identify the one or more isotopes, explosives or special materials contained in a container under examination. With respect to radiation detection, the spectral analyzer 440 compares one or more spectral images of the radiation present to known isotopes that are represented by one or more spectral images 450 stored in the isotope database 422.

By capturing multiple variations of spectral data for each isotope there are numerous images that can be compared to one or more spectral images of the radiation present. The isotope database 422 holds the one or more spectral images 450 of each isotope to be identified. These multiple spectral images represent various levels of acquisition of spectral radiation data so isotopes can be compared and identified using various amounts of spectral data available from the one or more sensors. Whether there are small amounts (or large amounts) of data acquired from the sensor, the spectral analysis system 440 compares the acquired radiation data from the sensor to one or more spectral images for each isotope to be identified. This significantly enhances the reliability and efficiency of matching acquired spectral image data from the sensor to spectral image data of each possible isotope to be identified. Once the one or more possible isotopes are determined present in the radiation detected by the sensor(s), the information processing system 412 can compare the isotope mix against possible materials, goods, products, or any combination thereof, that may be present in the container under examination.

Additionally, a manifest database 415 includes a detailed description of the contents of each container that is to be examined. The manifest 415 can be referred to by the information processing system 412 to determine whether the possible materials, goods, or products, contained in the container match the expected authorized materials, goods, or products, described in the manifest for the particular container under examination. This matching process, according to one embodiment of the present invention, is significantly more efficient and reliable than any container contents monitoring process in the past.

The spectral analysis system 440, according to one embodiment, includes an information processing system and software that analyzes the data collected and identifies the isotopes that are present. The spectral analysis software consists of more that one method to provide multi-confirmation of the isotopes identified. Should more than one isotope be present, the system identifies the ratio of each isotope present. Examples of methods that can be used for spectral analysis such as in the spectral analysis software according to an embodiment of a container contents verification system, include: 1) a margin setting method as described in U.S. Pat. No. 6,847,731; and 2) a LINSCAN method (a linear analysis of spectra method) as described in U.S. patent application Ser. No. 11/624,067, by inventor David L. Frank, and entitled “Method For Determination Of Constituents Present From Radiation Spectra And, If Available, Neutron And Alpha Occurrences”; the collective entire teachings of which being herein incorporated by reference.

With respect to analysis of collected data pertaining to explosives and/or special materials, the spectral analyzer 440 and the information processing system 412 compare identified possible explosives and/or special materials to the manifest 415 by converting the stored manifest data relating to the shipping container under examination to expected explosives and/or radiological materials and then by comparing the identified possible explosives and/or special materials with the expected explosives and/or radiological materials. If the system determines that there is no match to the manifest for the container then the identified possible explosives and/or special materials are unauthorized. The system can then provide information to system supervisory personnel to alert them to the alarm condition and to take appropriate action. The user interface 414, for example, can present to a user a representation of the collected received returning signals, or the identified possible explosives and/or special materials in the shipping container under examination, or any system identified unauthorized explosives and/or special materials contained within the shipping container under examination, or any combination thereof.

The data collection system can also be communicatively coupled with a remote control and monitoring system 418 such as via a network 416. The remote system 418 comprises an information processing system that has a computer, memory, storage, and a user interface 420 such as a display on a monitor and a keyboard, or other user input/output device. The network 416 comprises any number of local area networks and/or wide area networks. It can include wired and/or wireless communication networks. This network communication technology is well known in the art. The user interface 420 allows remotely located service or supervisory personnel to operate the local system 412 and to monitor the status of shipping container verification by the collection of sensor units 401, 402 and 403 deployed on the frame structure.

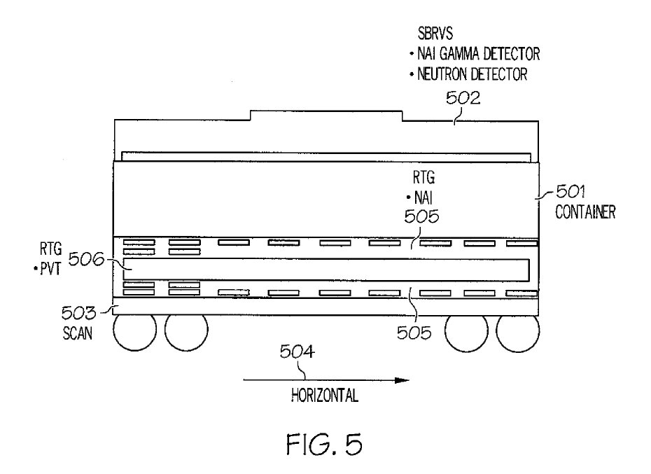

With reference to FIG. 5, illustrating an RTG/spreader bar sensor arrays overview, sensors are applied in a horizontal array to address the bottom portion of the container. The sensors are grouped at the front of the array to enable a scanning capability. The sensors are distributed across the horizontal line of the bottom portion of the container to continue to analyze the contents while the container is in the detector zone.

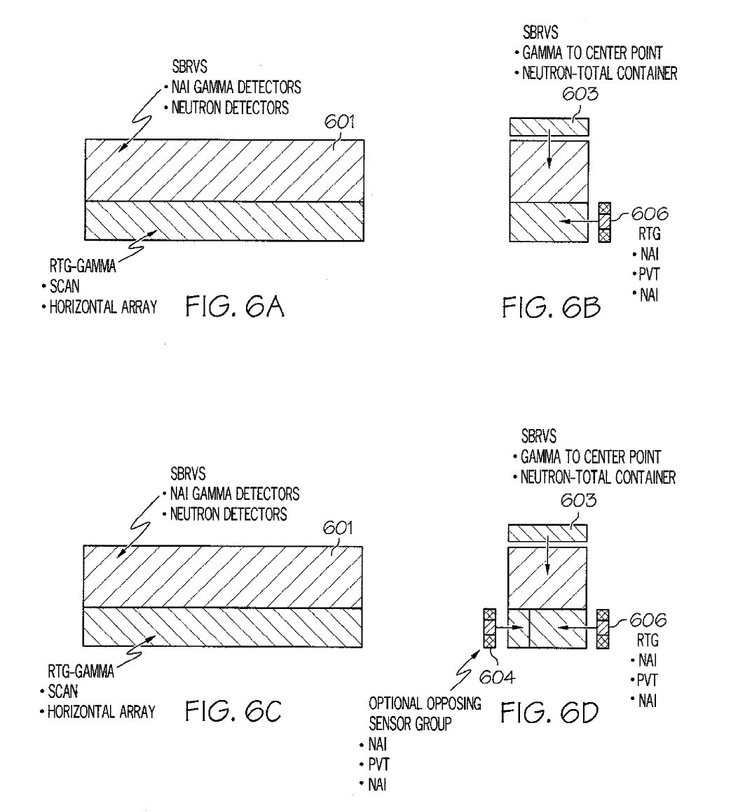

With reference to FIG. 6, illustrating one example of sensor/detector coverage of a container, the diagram shows the sensor/detector coverage from both the spreader bar and the side mounted detectors.

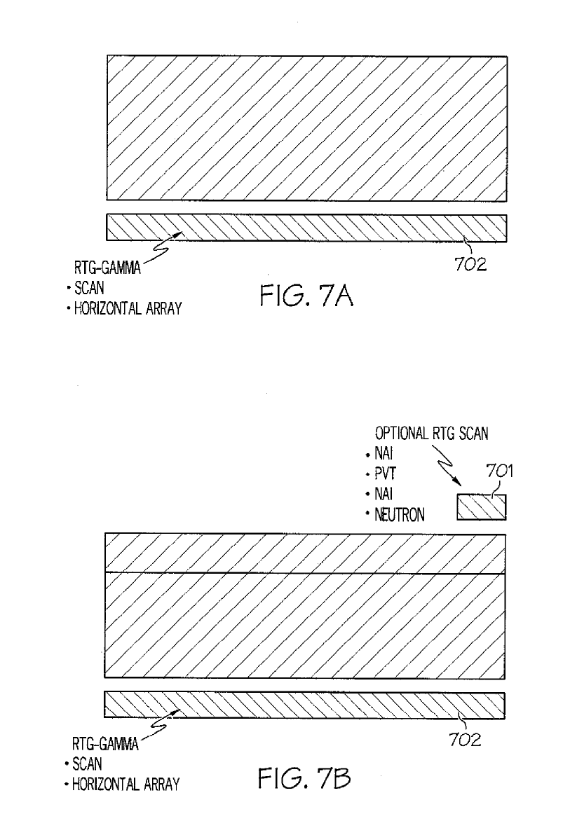

FIG. 7 illustrates the scanning and horizontal sensors, and FIG. 8 illustrates the deployment of neutron detectors on to the RTG sensor modules.

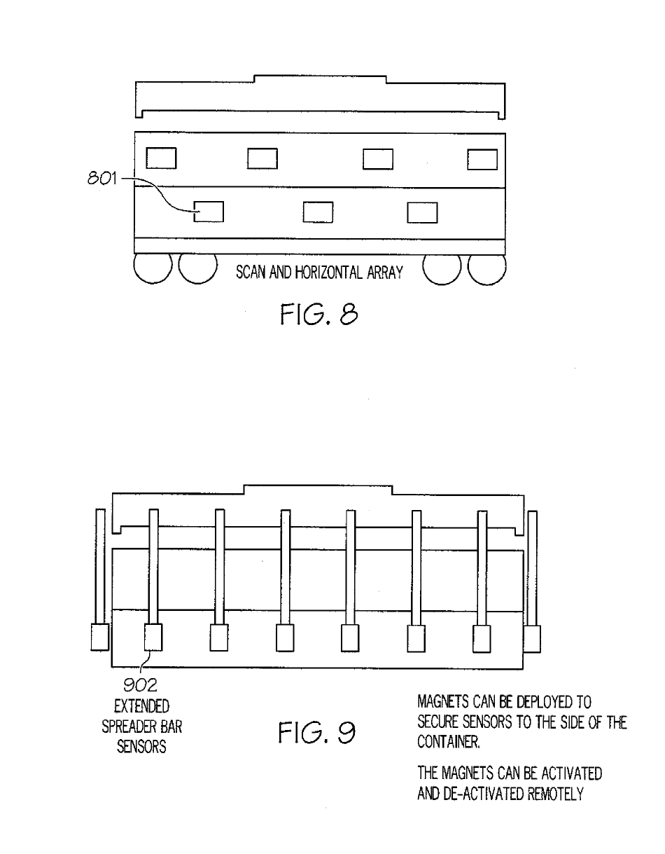

With reference to FIG. 9, the spreader bar provides flexible extended sensors 902 down to the bottom portion of the container and can scope the detectors out to cover additional area.

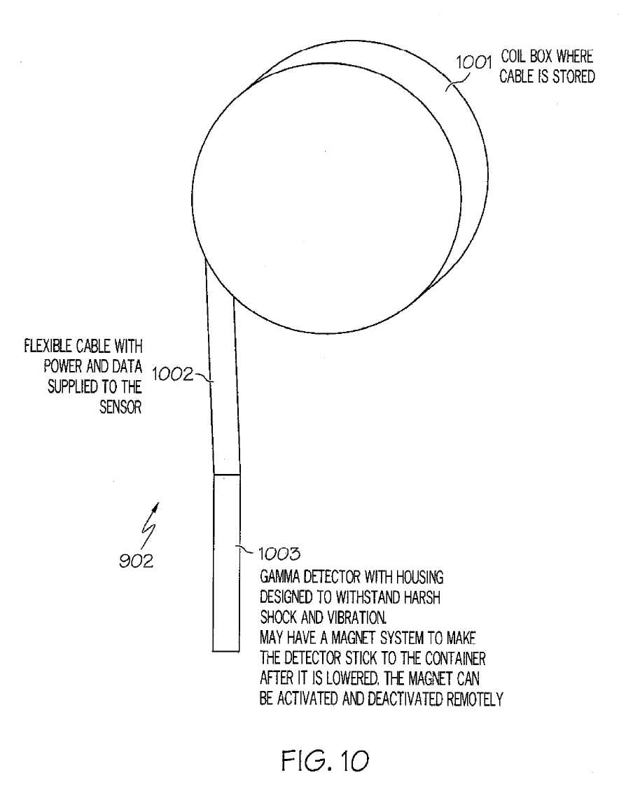

FIG. 10 shows an example of a SBRVS-flexible sensor coil. Flexible cable with power and data supplied to the sensor 1002 is deployed from a Coil Box 1001 where cable is stored. The Gamma detector, in this example, includes a housing designed to withstand harsh shock and vibration. A magnet system 1003 (such as an electro-magnet) can assist guiding the detector 902 by sticking to the container (via magnetic attraction force) after it is lowered. The magnet can be activated and deactivated remotely.

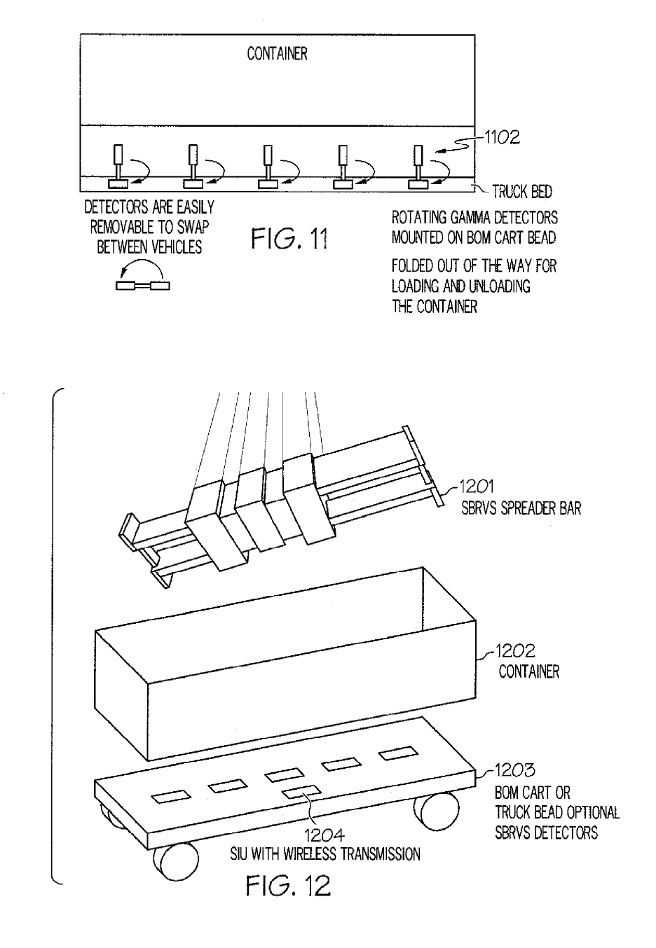

With reference to FIG. 11, the extended sensors could also be deployed on the truck bed or BOM Cart used to transport a container at the port. In this configuration the sensors 1102 are deployed on the sides of the bed and can fold down out of the way during container loading or when not being used. The sensors 1102 can also be designed for easy removal to store the sensors or deploy them on another vehicle.

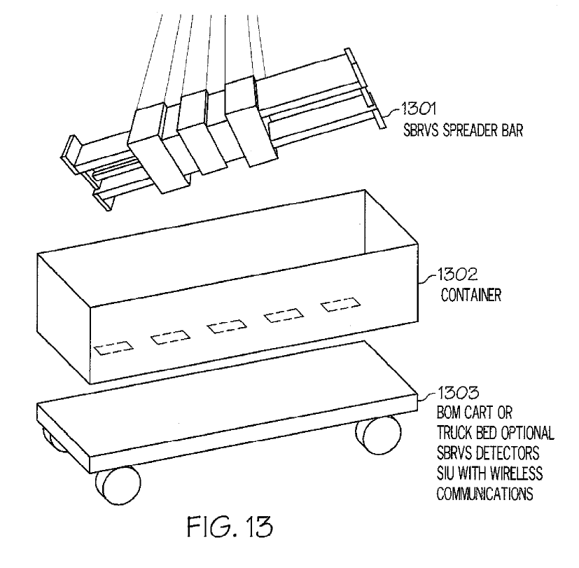

With reference to FIG. 12, a spreader bar 1201 detection system provides extended sensors down at the bottom portion of the container 1202, in one embodiment, through embedded detectors 1203 installed in a truck bed or BOM cart. An SIU 1204 with wireless communication capability can also be located at the truck bed or BOM cart. As shown in FIG. 13, a spreader bar 1301 detection system provides extended sensors down at the sides of the container 1302, and optional detectors and SIU 1303 are also located in a truck bed or BOM cart. The SIU has wireless communication capability.

As has been discussed above, various embodiments of the present invention can include a plurality of detector arrays mounted on a respective plurality of sides of the mobile frame structure to cover multiple sides of a container with detectors and thereby cover the entire contents of the container. One or more detector arrays can also be mounted on the spreader bar system. The combination of sensors/detectors located around multiple sides of a container cover the entire contents of the container.

Various embodiments of the present invention provide an efficient and cost effective means to overcome difficulties of deploying arrays of gamma and neutron detectors on a spreader bar or other container movement equipment. These detectors are utilized for the collection of radiation spectral data from containers. The system digitizes and processes the detector data, and it manages the detectors within the array and the communications systems used to deliver detector data to a processor for spectral analysis and isotope identification.

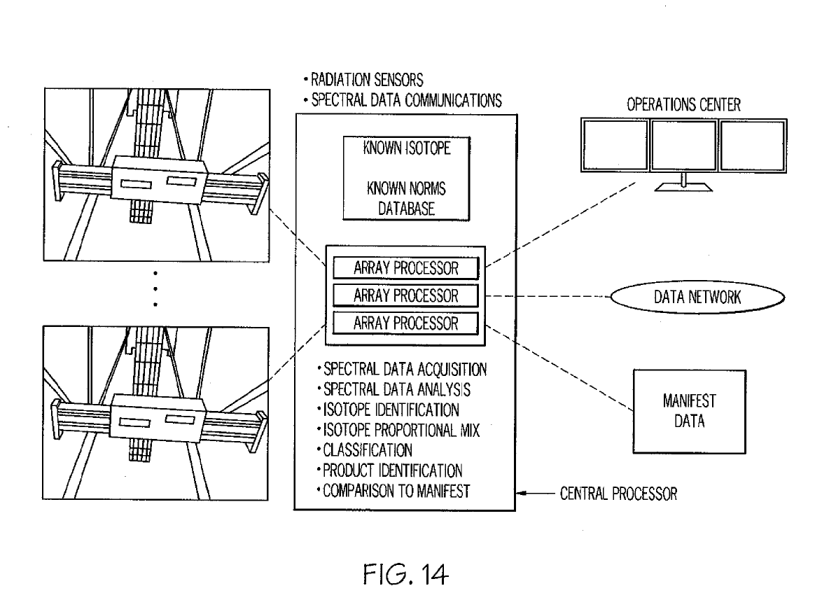

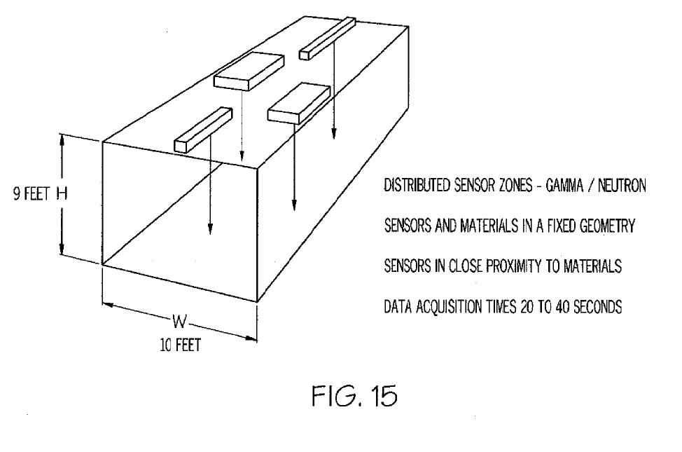

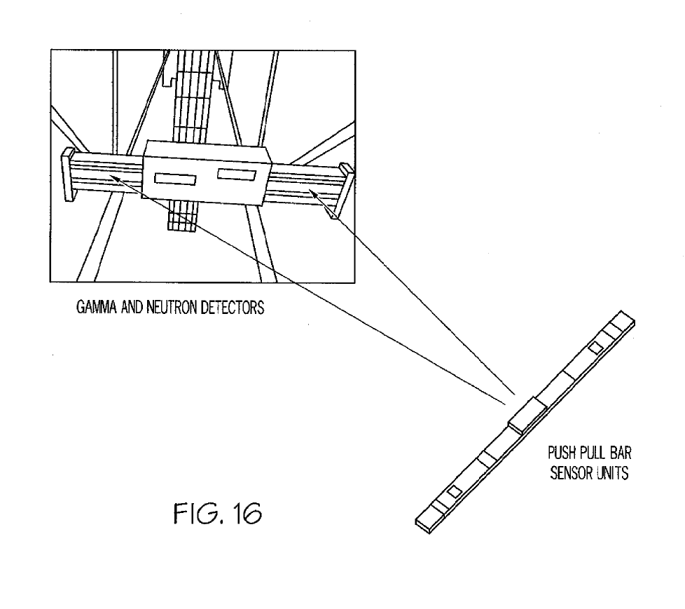

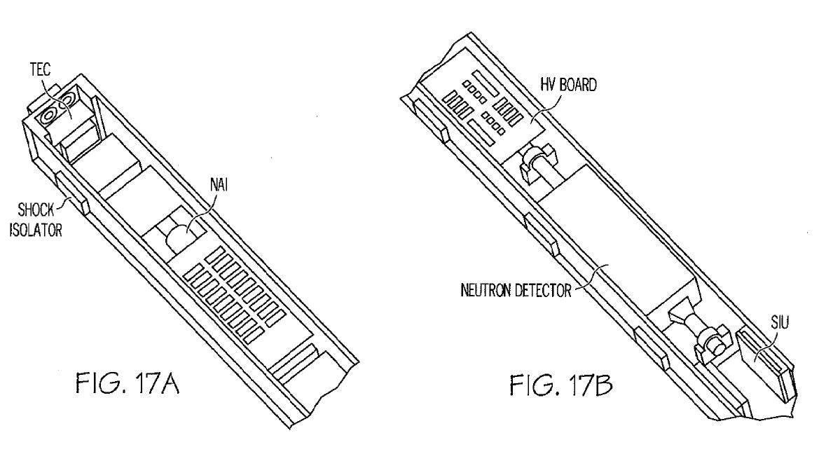

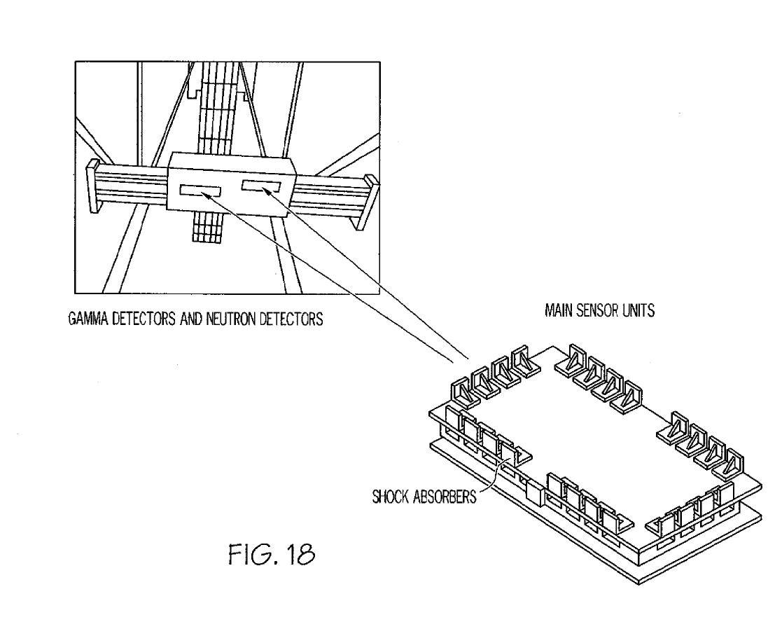

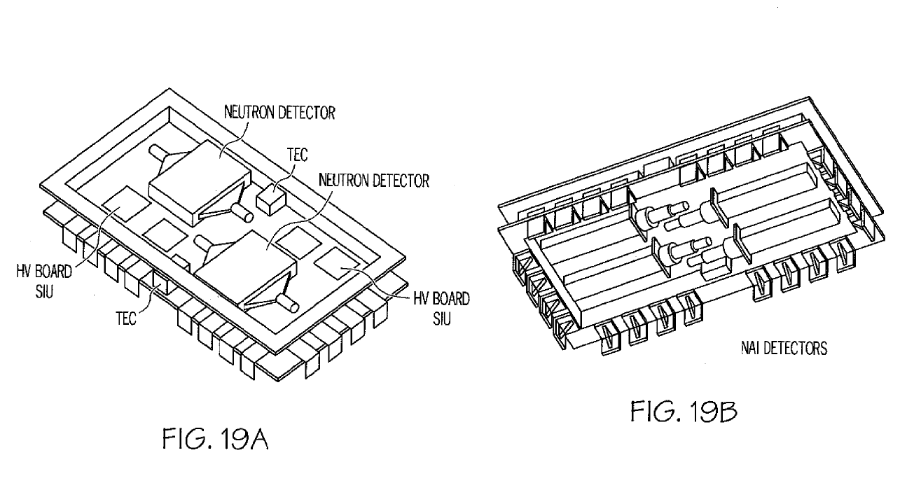

According to these various embodiments, specialized housings enable integration of gamma and neutron detector arrays on a gantry crane spreader bar or on other container movement equipment. See, for example, FIGS. 14, 15, 16, 17, 18, and 19. The sensor modules are designed to withstand harsh environmental conditions including: rain, heat, cold, vibration, shock, electromagnetic interference, radio frequency interference and seaport environments. The sensor module housings are designed to enable multiple detectors a variety of types and sizes for optimum radiation detection and minimal space requirements. The sensor module housing can be designed to be integrated into the push pull bar, as shown in FIGS. 16 and 17, or integrated into the actual spreader bar of a spreader bar system, to expand and contract the sensor positions for a variety of container sizes. The sensor module housings are also designed for integration within the main body of the spreader bar system, as illustrated in FIGS. 18 and 19.

The sensor module housings have shock isolation mounts, such as shown in FIG. 23, that connect the sensor module housing to the spreader bar and shock absorbing mounts for the detectors and electronics within the sensor module housings. The sensor module housings are designed to protect the sensor modules, detectors, and electronics within the sensor modules, for the shock and vibration that occurs on the spreader bar during normal operation without the need for specialized shock absorbing systems deployed as part of the spreader bar mechanics.

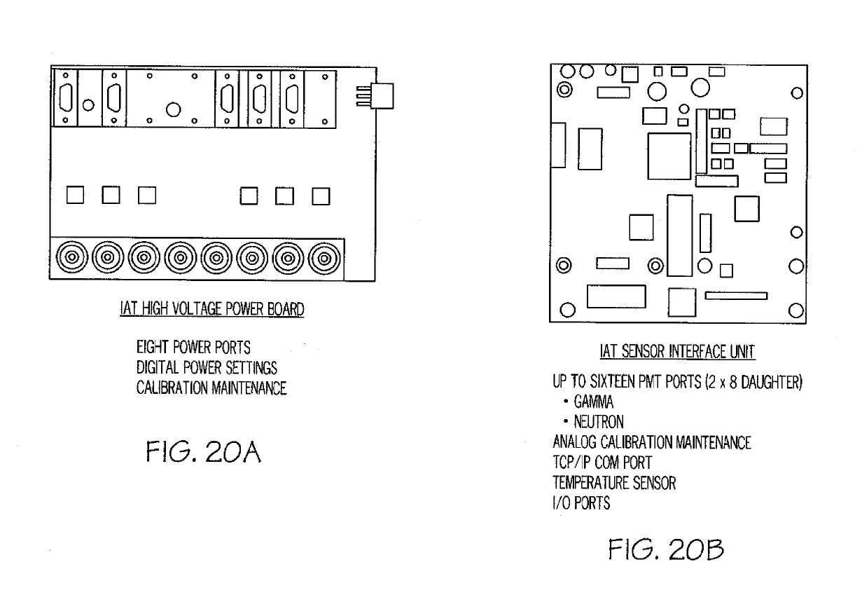

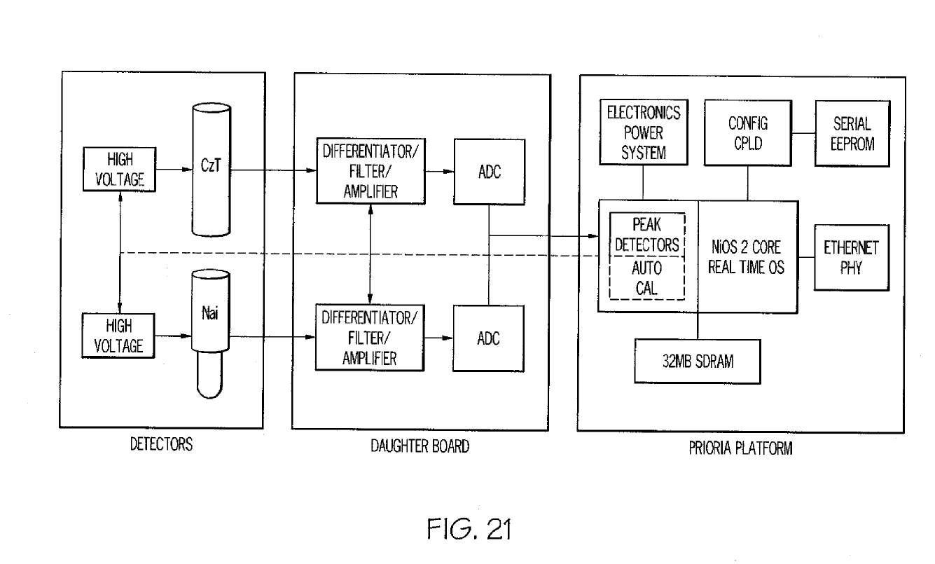

This arrangement of sensors and sensor housings provides an efficient system for the deployment of multiple detectors within each sensor module deployed on a gantry crane spreader bar or on other container movement equipment. One or more sensor interface units (SIU) are deployed within each sensor module to collectively interface multiple gamma and or neutron detectors, such as shown in FIGS. 20 and 21.

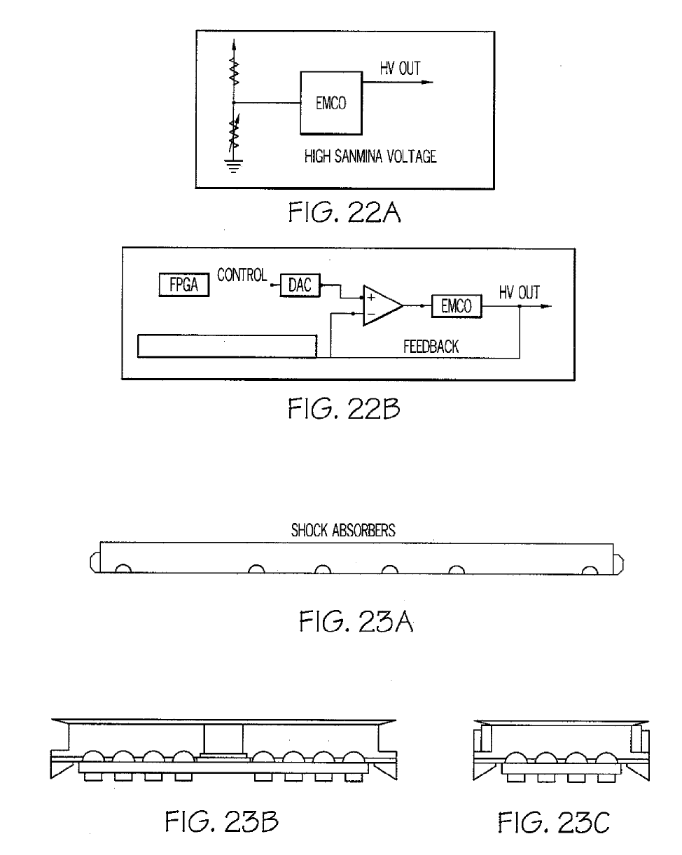

The sensor interface unit provides the high voltage power supplies in support of the one or more gamma and neutron detectors. The high voltage power supply, as shown in FIGS. 20 and 21, provides a digital potentiometer controlled via software commands to set the voltage to the gamma or neutron detector at a precise value. The high voltage power supply has a voltage locking circuit to maintain the precise voltage setting, as shown in FIG. 22. This digital voltage setting can be used to calibrate the gamma or neutron detector.

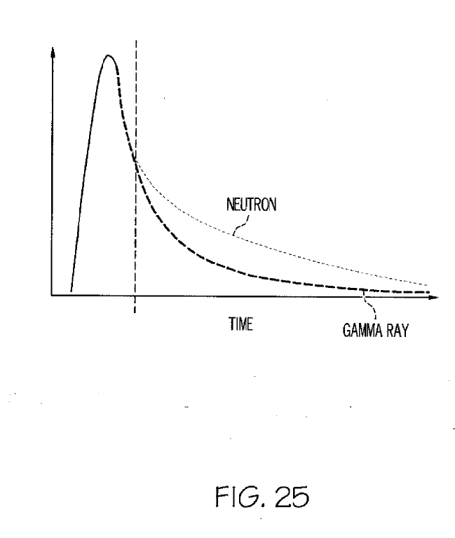

The sensor interface unit provides an analog interface to receive signals from the one or more gamma or neutron detectors within the sensor module. The sensor interface unit analog interface to the gamma or neutron detectors has a digital gain control to allow calibration of the detector signals. The sensor interface unit provides analog to digital signal conversion to digitize the sensor data, analyze the energy level of the gamma signal and assign the detected signal to an energy bin to accumulate counts of gamma energy at that specific energy level. The sensor interface unit collects this detector data over time and creates a histogram of the collected energy levels. The sensor interface unit provides an analog interface to the neutron detectors and provides analog to digital signal conversion to digitize the sensor data. The system analyzes the digitized sensor data to determine the energy level of the gamma signal to differentiate between neutron detections, as shown in FIG. 25, and high energy gamma noise and other interfering signals to enable an efficient detection of neutrons. A pulse shape differentiation method is used to filter noise from collected detector radiation data from at least one neutron detector. The system accumulates counts of neutron energy and adds this information collected over time to the histogram.

The sensor interface unit has a processor and communications capability. Each detector is assigned a TCP/IP address and the sensor unit is assigned a TCP/IP address. The sensor interface unit enables communications of collected detector data between the individual detectors and the data network. The data network can transmit the collected detector data to one or more processors for analysis. The sensors deployed in the sensor units, according to one embodiment, include a noble gas ionization chamber that provides a stable signal without significant analog drift to enable a baseline reference for the calibration of the scintillation detector devices for gamma spectral acquisition.

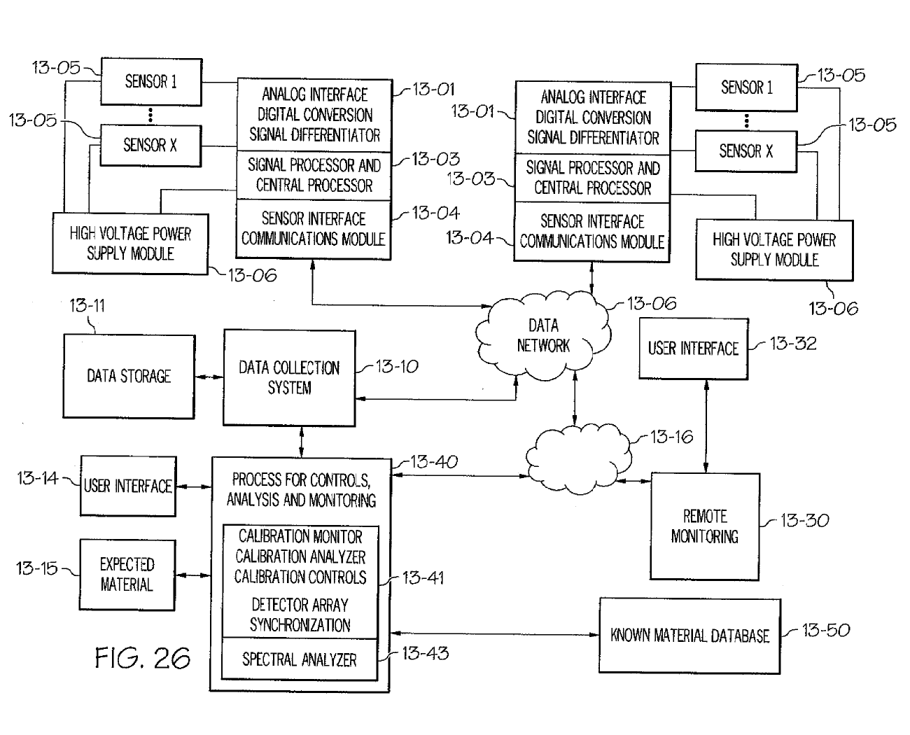

The radiation verification software system, as shown in FIG. 26, utilizes the detectors (13-05) within the sensor modules to gather radiation spectral data and processes that data for isotope identification. The radiation verification software system communicates with the digital high voltage power supply module to control the digital power settings (13-06). This software system monitors the calibration for each individual detector (13-41). The software system uses a known radiation in the background as a reference to verify calibration for each detector. The software systems can modify the high voltage (13-06) supplied to the detector to affect calibration. The software systems can modify the analog interface from the detector affect calibration (13-01). The software systems can also modify the sensor data received to affect calibration (13-41). The ability to perform isotope identification or any type of comparison of the collected radiological data (13-40) to a known database of radiological materials (13-50) requires accurate and continuous calibration of the detectors. To merge the collected radiological data for gross analysis, the detector array must be synchronized. The software system can use all three calibration methods (13-06, 13-01, and 13-41) to calibrate the individual detectors to a standard calibration to ensure detector array synchronization.

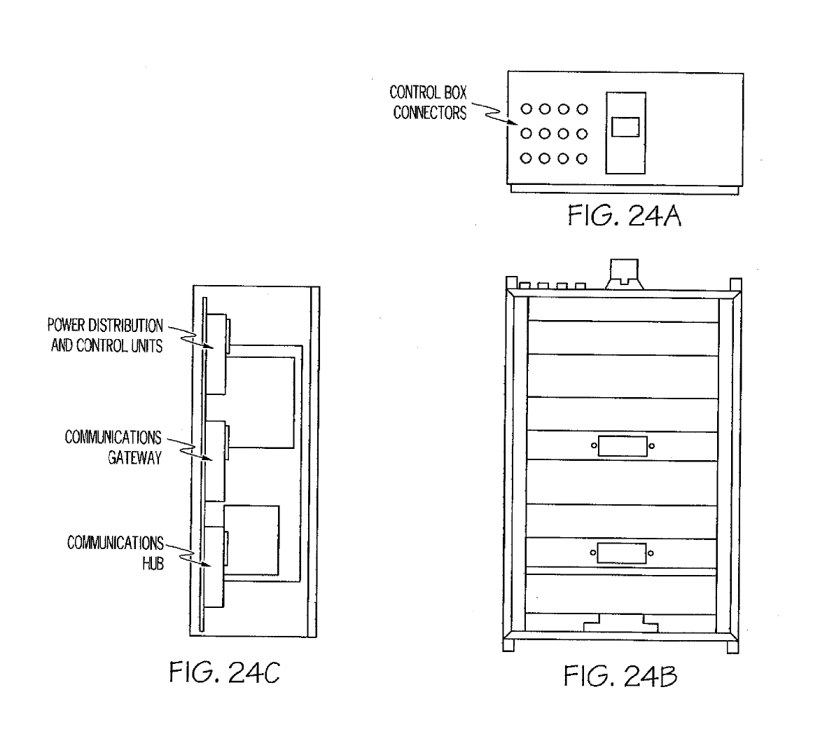

The present example includes a control box (see FIG. 24) deployed on the spreader bar for distribution of power to the sensor modules, a data communications hub between the sensor modules, a gateway to the data network, and interconnections between the spreader bar controls and the spreader bar radiation verification systems. The control box provides a power distribution system for all of the electrical components on the spreader bar radiation verification system including but not limited to: sensor interface units, high voltage power supplies for gamma and neutron detectors, communications equipment, cooling and heating equipment. An example of a DC control box power distribution system is the Spectrum Control DC SMARTstart, which is a 48V DC power distribution and circuit protection unit designed to maximize network uptime and protect valuable client network equipment. The DC SMARTstart has specialized electronic circuit breakers which can trip up to 10× faster than conventional circuit breakers. The unit also features integral circuitry to provide LVD and OVD protection automatically. Alternating Current power distribution and control systems can also be used.

The DC SMARTstart features the ability to reset nuisance circuit breaker trips that result from short surges or brief computational loads. The DC SMARTstart PDU will control and monitor two sets of six independent loads. Each output channel is configured at the factory and rated steady state at 4 Amps for the 30 Amp design and 10 Amps each for the 60 Amp configuration. The SMARTstart PDU features a visual basic (VB) Interface to program the power up/down sequence and power up/down delays for each channel, along with the LVD and OVD thresholds. Operational control is performed either manually by front panel push buttons or remotely through either a console port 10/100 BASE-T or LAN TCP/IP socket or telnet session.

The control box provides a data communications hub between the sensor modules and a communications gateway to the data network. The communications gateway can use wire-line, wireless or satellite communications. In the case of the spreader bar on a gantry crane, the communications media across the baloney cable connecting the spreader bar to the gantry crane has limited options. Fiber optic communications can be used, but is expensive to deploy and maintain. Alternatives to fiber optics are: Ethernet over copper wires and broadband over power lines. The close proximity of the copper pairs allocated for communications to the power lines within the baloney cable cause substantial inductive interference. To address the conductive interference we use a broadband over power lines (BPL) technology that allows us to use the power lines that cause the inductive interference as the transmission media. The control box can contain local processors for sensor data analysis or the detector data can be transmitted to a remote processor for analysis.

Carrier vehicles, such as the spreader bar of a gantry crane, can be equipped with gamma and neutron sensors to provide the capability to determine if hazardous materials such as radioactive materials have been placed in the container. Examples of container transport vehicles include: trucks, trains, container movement equipment, cargo and mail carriers, gantry cranes, spreader bars for container movement, airplanes, ships, etc.

Carrier facilities such as a shipping terminals equipped with gantry cranes to move the shipping containers between the ship and port have the capability to deploy gamma and neutron sensors on the spreader bar to collect spectral data for analysis to determine if hazardous materials such radioactive materials are being deposited within the cargo at the facility. Examples of carrier facilities include: cargo terminals, railway terminals, shipping terminals, sea ports, airports, mail and cargo collection facilities.

By operating the radiation verification system remotely, such as from a central monitoring location, a larger number of sites can be safely monitored by a limited number of supervisory personnel.

Various preferred embodiments of the present invention can be realized in hardware, software, or a combination of hardware and software. A system according to a preferred embodiment can be realized in a centralized fashion in one computer system or in a distributed fashion where different elements are spread across several interconnected computer systems. Any kind of computer system—or other apparatus adapted for carrying out the methods described herein—is suited. A typical combination of hardware and software could be a general purpose computer system with a computer program that, when being loaded and executed, controls the computer system such that it carries out the methods described herein.

An embodiment according to present invention can also be embedded in a computer program product that comprises all the features enabling the implementation of the methods described herein, and which—when loaded in a computer system—is able to carry out these methods. Computer program means or computer program in the present context mean any expression, in any language, code or notation, of a set of instructions intended to cause a system having an information processing capability to perform a particular function either directly or after either or both of the following a) conversion to another language, code or, notation; and b) reproduction in a different material form.

Each computer system may include one or more computers and at least a computer readable medium allowing a computer to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer readable medium may include, for example, volatile storage such as RAM, buffers, cache memory, and network circuits. Furthermore, the computer readable medium may comprise computer readable information in a transitory state medium such as a network that allows a computer to read such computer readable information.

### NON-LIMITING EXAMPLES

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A mobile frame structure configured for cargo container transport, with a set of distributed sensors mounted thereon and operable in close proximity to two or more sides of a container under inspection, comprising:
a mobile frame structure configured for cargo container transport, the mobile frame structure including a spreader bar attached to the mobile frame structure;
first set of one or more gamma and/or neutron detectors mounted on at least one side of the mobile frame structure;
second set of one or more gamma and/or neutron detectors mounted on the spreader bar;
an analog signal to digital data converter, communicatively coupled with at least one detector of the first set and the second set to convert analog signal therefrom to digital data;
a communications device to couple the digital data to a communications network;
a high voltage power supply to provide power to the at least one detector of the first set and second set under software control to adjust the provided power for calibration of the detector;
a digital data collection system, communicatively coupled with the first set and second set of detectors, for collection of detector radiation data;
a multi-channel analyzer system, communicatively coupled with the digital data collection system, for preparing histograms of the collected detector radiation data;
a spectral analysis system, communicatively coupled with the multi-channel analyzer system and the digital data collection system, for receiving and analyzing the collected data and the histograms to detect and to identify one or more chemical, biological, radiation, nuclear or explosives (CBRNE) materials that are present within the container under inspection;
a first data storage means, communicatively coupled with the spectral analysis system, for storing data representing CBRNE spectra for use by the spectral analysis system, where one or more spectral images stored in the first data storage means represent at least one isotope; and
an information processing system, communicatively coupled with the spectral analysis system, for analyzing the identified one or more CBRNE materials to determine possible materials or goods that they represent.

2. The mobile frame structure of claim 1, wherein the mobile frame structure comprises at least one of a gantry crane and cargo transport equipment, that is configured as part of a radiation detection and isotope identification system, the first set of detectors being mounted on at least one side of the at least one of the gantry crane and cargo transport equipment.

3. The mobile frame structure of claim 1, further comprising a second data storage means for storing data representing a manifest relating to the contents of the container under inspection, the second data storage means being communicatively coupled with the information processing system, the information processing system further for comparing the determined possible materials or goods with a manifest relating to the container under inspection to determine if there are unauthorized materials or goods contained within the container under inspection.

4. The mobile frame structure of claim 1, wherein the multi-channel analyzer system uses a reference signal associated with at least one detector of the first set and second set of detectors to adjust the collected detector radiation data to obtain proper calibration of the collected detector radiation data.

5. The mobile frame structure of claim 1, wherein the spectral analysis system analyzes the collected detector radiation data and the histograms to detect radiation and to identify one or more isotopes associated with the detected radiation by using software on a computer program product.

6. The mobile frame structure of claim 1, wherein the spectral analysis system analyzes the collected detector radiation data and the histograms to detect radiation and to identify one or more isotopes associated with the detected radiation by a pulse shape differentiation method employed to filter noise from collected detector radiation data from at least one neutron detector in the first set and second set of detectors.

7. The mobile frame structure of claim 1, wherein the first set of detectors comprises a plurality of detector arrays mounted on a respective plurality of sides of the mobile frame structure.

8. A multi-sided gamma detector array, comprising:
gamma detectors deployed on a spreader bar and operable at a top side of a container under inspection as a top side detector array; and
gamma detectors deployed on at least one side of a moveable frame structure operable on at least one side of the container under inspection as at least one of a right side detector array, a left side detector array, and a bottom side detector array, extending detectors down to a bottom area of the container under inspection, the combination of the top side detector array and the at least one of a right side detector array, a left side detector array, and a bottom side detector array, operable in detection and isotope identification of low amounts of radiological activity at all locations within the container under inspection.

9. The multi-sided gamma detector array of claim 8, wherein the moveable frame structure comprises at least one of a gantry crane, a rail mounted gantry crane, a rubber tire gantry crane, a BOM cart, and a truck bed, and wherein the gamma detectors are mounted on at least one side of the at least one of the gantry crane, the rail mounted gantry crane, the rubber tire gantry crane, the BOM cart, and the truck bed, and operable at a side of the container under inspection as at least one of a right side detector array, a left side detector array, and a bottom side detector array, extending detectors down to a bottom area of the container under inspection.

10. The multi-sided gamma detector array of claim 8, wherein the moveable frame structure comprises a gantry crane, and wherein the gamma detectors are mounted on at least one side of the gantry crane, and operable at a side of the container under inspection as at least one of a right side detector array, a left side detector array, and a bottom side detector array, extending detectors down to a bottom area of the container under inspection.

11. The multi-sided gamma detector array of claim 10, wherein the gamma detectors are mounted on a plurality of sides of the gantry crane, and operable, in combination with the gamma detectors deployed on the spreader bar, at a plurality of sides of the container under inspection as a multi-sided gamma detector array operable in detection and isotope identification of low amounts of radiological activity at all locations within the container under inspection.

12. The multi-sided gamma detector array of claim 8, wherein the moveable frame structure comprises a gantry crane, and wherein the gamma detectors are mounted on one side of the gantry crane, and operable at a bottom side of the container under inspection as a bottom side detector array, and in combination with the gamma detectors deployed on the spreader bar, operable at a top side and a bottom side of the container under inspection as a multi-sided gamma detector array operable in detection and isotope identification of low amounts of radiological activity at all locations within the container under inspection.

13. A multi-sided gamma detector array mounted on a spreader bar system and moveable gantry crane, comprising
gamma detectors deployed on a spreader bar providing for a top side array at a top region of a container under inspection; and
gamma detectors deployed on a side of a moveable gantry crane providing for a side detector array extending gamma detectors down to a bottom region of a container under inspection, to enable detection and isotope identification of low amounts of radiological activity at all locations within a container under inspection.

14. The multi-sided gamma detector array of claim 13, wherein the moveable gantry crane includes the spreader bar.

15. The multi-sided gamma detector array of claim 13, wherein the gamma detectors deployed on the spreader bar are shock mounted in at least one sensor module integrated into at least one of a push pull bar, an actual spreader bar of a spreader bar system, and a main body of a spreader bar system.

16. The multi-sided gamma detector array of claim 13, wherein each of the at least one sensor module is connected to the spreader bar by shock isolation mounts that are part of a sensor module housing, and gamma detectors deployed in each of the at least one sensor module are connected to the sensor module housing by shock absorbing mounts.

17. The multi-sided gamma detector array of claim 13, wherein the gamma detectors deployed in each of the at least one sensor module are located inside the sensor module housing and connected to the sensor module housing by shock absorbing mounts.
